(19) United States
(12) Patent Application Publication
(10) Pub. No.: US 2019/0353998 A1
(43) Pub. Date: Nov. 21, 2019

(54) PROJECTION DEVICE

(71) Applicant: QISDA CORPORATION, Taoyuan City (TW)

(72) Inventors: Chi-Hung Hsiao, Taoyuan City (TW); Tsung-Hsun Wu, Taoyuan City (TW)

(21) Appl. No.: 16/368,839

(22) Filed: Mar. 28, 2019

(30) Foreign Application Priority Data
May 16, 2018 (CN) 201810469297.4

(51) Int. Cl. G03B 21/20; G03B 21/16

(52) U.S. Cl. CPC G03B 21/2013; G03B 21/2066; G03B 21/16

(57) ABSTRACT

A projection device includes a first light source, a second light source, a driving unit, a reflecting member and a light integrator. The driving unit and the first light source are located at opposite sides of a second light axis of the second light source. The driving unit and the second light source are located at opposite sides of a first light axis of the first light source. The driving unit drives the reflecting member to move between a first position and a second position. When the reflecting member is located at the first position, the first light source emits a first light along the first light axis to the light integrator. When the reflecting member is located at the second position, the second light source emits a second light along the second light axis and the reflecting member reflects the second light to the light integrator.

### BACKGROUND OF THE INVENTION

### 1. Field of the Invention

The invention relates to a projection device and, more particularly, to a projection device capable of extending the lifetime of a light source.

### 2. Description of the Prior Art

Recently, projectors are getting more and more popular. With the capacity of video playing, projectors are applied not only for common office meetings, but also for various seminars or academic courses. In general, a projector may comprise various optical components including a lens, a light source, an optical engine module and so on, wherein the light source is configured to emit light beam and the light beam is processed by the optical engine module and then projected to form an image through the lens. Accordingly, the light source is an important optical component in the projector. Generally speaking, after being used for a long time, the lifetime of the light source is reduced due to brightness decay and then the performance of the projector is affected. Therefore, how to extend the lifetime of the light source of the projector has become a significant design issue.

### SUMMARY OF THE INVENTION

An objective of the invention is to provide a projection device capable of extending the lifetime of a light source, so as to solve the aforesaid problems.

In an embodiment of the invention, a projection device comprises a first light source, a second light source, a driving unit, a reflecting member and a light integrator. The first light source has a first light axis. The second light source has a second light axis. The driving unit and the first light source are located at opposite sides of the second light axis. The driving unit and the second light source are located at opposite sides of the first light axis. The reflecting member is connected to the driving unit. The driving unit drives the reflecting member to move between a first position and a second position. The light integrator is located on the first light axis. When the reflecting member is located at the first position, the reflecting member is separated from the first light axis and the first light source emits a first light along the first light axis, such that the first light passes through the light integrator. When the reflecting member is located at the second position, the reflecting member intersects the second light axis, the second light source emits a second light along the second light axis, and the reflecting member reflects the second light to the light integrator, such that the second light passes through the light integrator.

As mentioned in the above, the invention disposes two light sources in the projection device and utilizes the driving unit to drive the reflecting member to move between two positions, so as to allow the light emitted by one of the two light sources to pass through the light integrator. Accordingly, when the projection device of the invention is operating, the two light sources can emit light by turns to extend the lifetime of the light source.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic view illustrating a projection device according to an embodiment of the invention, wherein the reflecting member is located at a first position.

FIG. 2 is a schematic view illustrating the reflecting member shown in FIG. 1 moving to a second position.

FIG. 3 is a side view illustrating the driving unit and the reflecting member shown in FIG. 1.

FIG. 4 is a schematic view illustrating a projection device according to another embodiment of the invention, wherein the reflecting member is located at a first position.

FIG. 5 is a schematic view illustrating the reflecting member shown in FIG. 4 moving to a second position.

FIG. 6 is a side view illustrating the driving unit and the reflecting member shown in FIG. 4.

### DETAILED DESCRIPTION

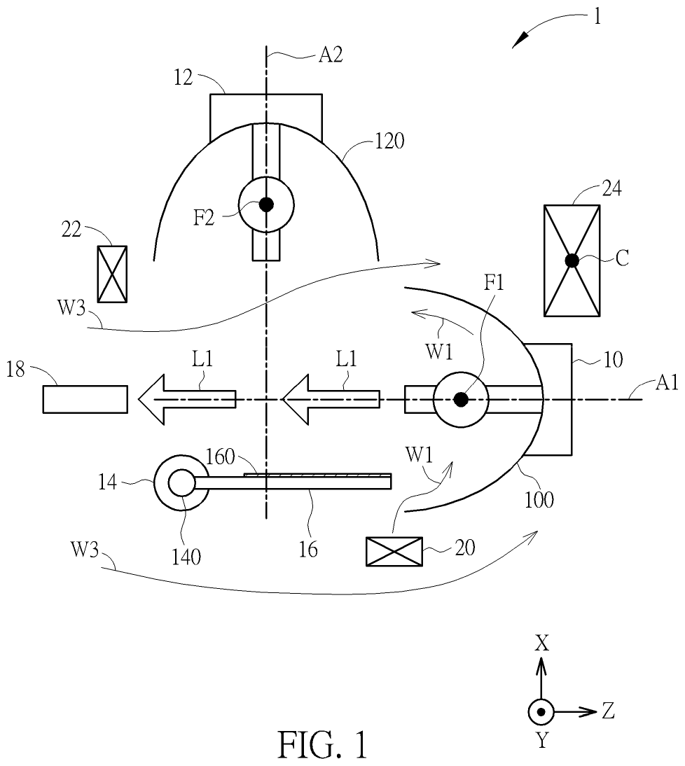

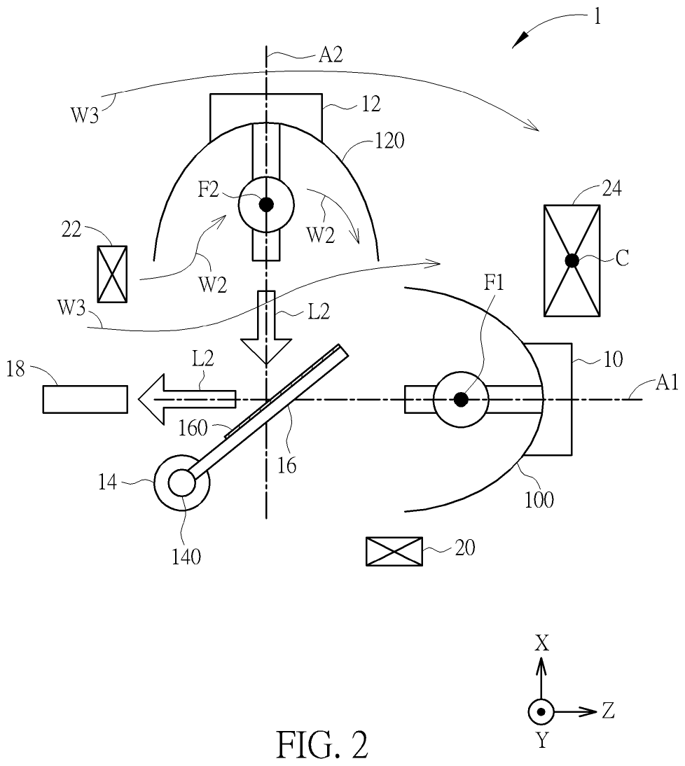

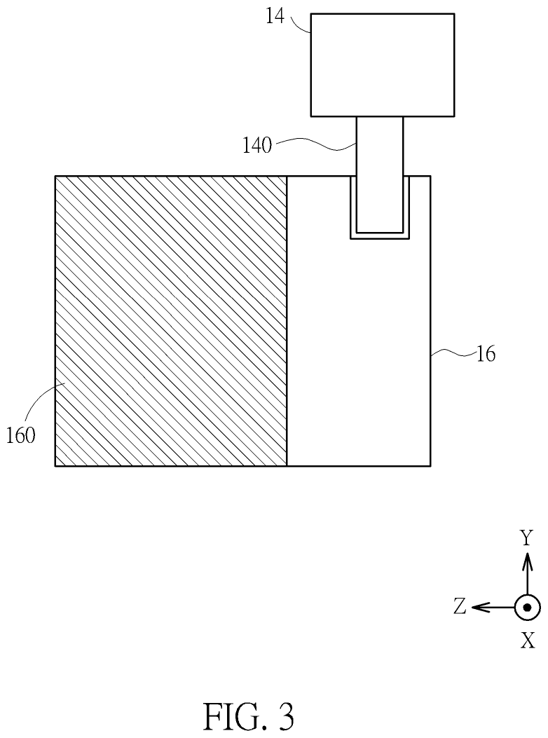

Referring to FIGS. 1 to 3, FIG. 1 is a schematic view illustrating a projection device 1 according to an embodiment of the invention, wherein the reflecting member 16 is located at a first position, FIG. 2 is a schematic view illustrating the reflecting member 16 shown in FIG. 1 moving to a second position, and FIG. 3 is a side view illustrating the driving unit 14 and the reflecting member 16 shown in FIG. 1.

As shown in FIGS. 1 and 2, the projection device 1 comprises a first light source 10, a second light source 12, a driving unit 14, a reflecting member 16, a light integrator 18, a first fan 20, a second fan 22 and a third fan 24. In practical applications, the projection device 1 may be a projector or other electronic devices with a projection function; the first light source 10 and the second light source 12 may be mercury lamps or the like; and the driving unit 14 may be a motor or other driving devices. In general, the projection device 1 may be further equipped with some necessary hardware or software components for specific purposes, such as a controller, a projection lens, a memory, a power supply, applications, a communication module, etc., and it depends on practical applications.

The first light source 10 has a first light axis A1 and the second light source 12 has a second light axis A2, wherein the light integrator 18 is located on the first light axis A1. The driving unit 14 and the first light source 10 are located at opposite sides of the second light axis A2 of the second light source 12. The driving unit 14 and the second light source 12 are located at opposite sides of the first light axis A1 of the first light source 10. In other words, the driving unit 14 is located at a position far away from the first light source 10 and the second light source 12. The reflecting member 16 is connected to the driving unit 14, such that the driving unit 14 is capable of driving the reflecting member 16 to move between a first position (as shown in FIG. 1) and a second position (as shown in FIG. 2). In this embodiment, the driving unit 14 has a rotating shaft 140. As shown in FIG. 3, the reflecting member 16 is connected to the rotating shaft 140 and a reflecting surface 160 (YZ plane) of the reflecting member 16 is parallel to the rotating shaft 140 (Y axis). Accordingly, when the rotating shaft 140 of the driving unit 14 rotates, the rotating shaft 140 can drive the reflecting member 16 to move between the first position shown in FIG. 1 and the second position shown in FIG. 2 along a direction parallel to the paper surface (XZ plane). In this embodiment, the invention may form the reflecting surface 160 by coating silver or other reflecting materials on the surface of the reflecting member 16.

When the projection device 1 of the invention is operating, the first light source 10 and the second light source 12 can emit light by turns to extend the lifetime of the first light source 10 and the second light source 12. As shown in FIG. 1, when the reflecting member 16 is located at the first position, the reflecting member 16 is separated from the first light axis A1 of the first light source 10. At this time, the projection device 1 may turn on the first light source 10 and turn off the second light source 12. Then, the first light source 10 emits a first light L1 along the first light axis A1, such that the first light L1 passes through the light integrator 18, so as to form an image by the first light L1. As shown in FIG. 2, when the reflecting member 16 is located at the second position, the reflecting member 16 intersects the second light axis A2 of the second light source 12. At this time, the projection device 1 may turn off the first light source 10 and turn on the second light source 12. Then, the second light source 12 emits a second light L2 along the second light axis A2 and the reflecting member 16 reflects the second light 12 to the light integrator 18, such that the second light L2 passes through the light integrator 18, so as to form an image by the second light L2.

In other words, the invention utilizes the driving unit 14 to drive the reflecting member 16 to move between the first position shown in FIG. 1 and the second position shown in FIG. 2 and selectively turns on one of the first light source 10 and the second light source 12, so as to allow the light emitted by one of the first light source 10 and the second light source 12 to pass through the light integrator 18. Accordingly, the invention can extend the lifetime of the first light source 10 and the second light source 12 effectively.

In this embodiment, the first fan 20 is disposed around the first light source 10 and the second fan 22 is disposed around the second light source 12. The first light source 10 may have a first reflecting cover 100 and the second light source 12 may have a second reflecting cover 120. Therefore, the first fan 20 may be disposed around the first reflecting cover 100 of the first light source 10 and the second fan 22 may be disposed around the second reflecting cover 120 of the second light source 12. Furthermore, the first fan 20 and the driving unit 14 are located at an identical side of the first light axis A1 of the first light source 10, and the second fan 22 and the driving unit 14 are located at an identical side of the second light axis A2 of the second light source 12.

Accordingly, as shown in FIG. 1, when the reflecting member 16 is located at the first position and the first light source 10 is turned on, a wind flow W1 generated by the first fan 20 can flow through the first light source 10 smoothly to dissipate heat from the first light source 10. That is to say, the wind flow W1 generated by the first fan 20 will not be blocked by the driving unit 14 and the reflecting member 16. Similarly, as shown in FIG. 2, when the reflecting member 16 is located at the second position and the second light source 10 is turned on, a wind flow W2 generated by the second fan 20 can flow through the second light source 12 smoothly to dissipate heat from the second light source 12. That is to say, the wind flow W2 generated by the second fan 20 will not be blocked by the driving unit 14 and the reflecting member 16. Therefore, the invention can enhance heat dissipation for the first fan 20 and the second fan 22 effectively.

In this embodiment, the third fan 24 is disposed at a side of the first light source 10 and the second light source 12, wherein an axial center C of the third fan 24 is located between a focus point F1 of the first reflecting cover 100 and a focus point F2 of the second reflecting cover 120. Accordingly, as shown in FIG. 1, when the reflecting member 16 is located at the first position and the first light source 10 is turned on, a wind flow W3 generated by the third fan 24 covers an area where the first light source 10 is located at, so as to dissipate heat from the first light source 10. Similarly, when the reflecting member 16 is located at the second position and the second light source 10 is turned on, a wind flow W3 generated by the third fan 24 covers an area where the second light source 12 is located at, so as to dissipate heat from the second light source 12. Therefore, the invention can enhance heat dissipation for the third fan 24 effectively.

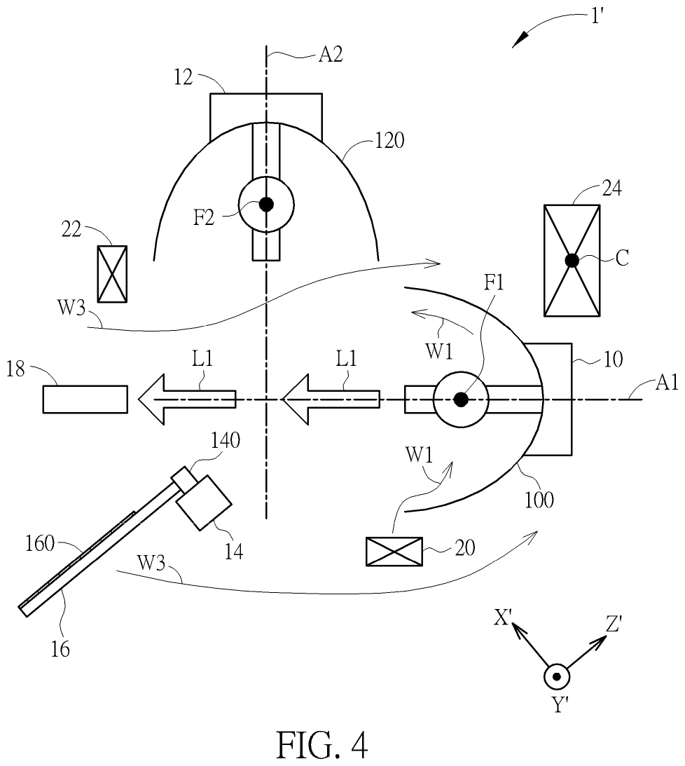

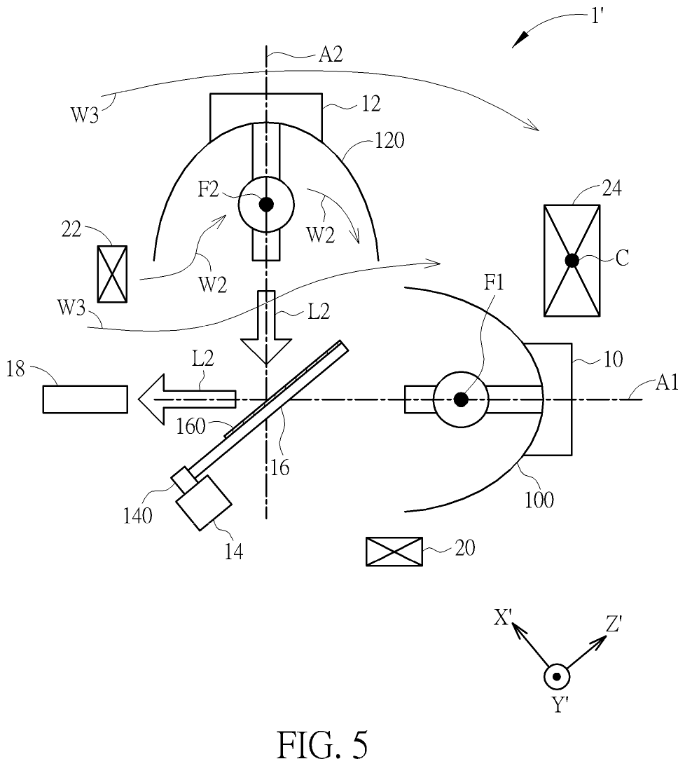

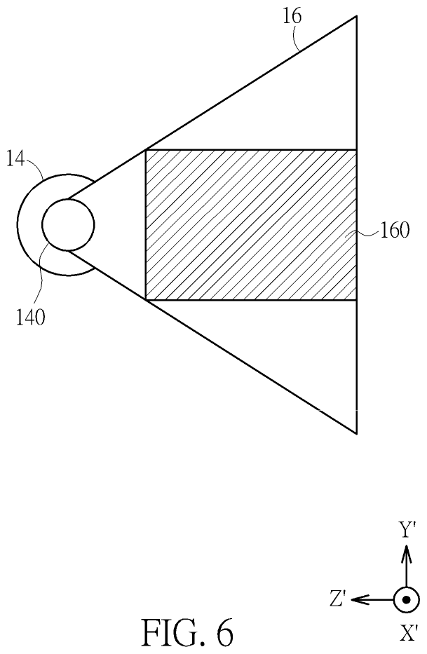

Referring to FIGS. 4 to 6, FIG. 4 is a schematic view illustrating a projection device 1′ according to another embodiment of the invention, wherein the reflecting member 16 is located at a first position, FIG. 5 is a schematic view illustrating the reflecting member 16 shown in FIG. 4 moving to a second position, and FIG. 6 is a side view illustrating the driving unit 14 and the reflecting member 16 shown in FIG. 4. The main difference between the projection device 1′ and the aforesaid projection device 1 is that the reflecting surface 160 (Y′ Z′ plane) of the reflecting member 16 of the projection device 1′ is perpendicular to the rotating shaft 140 of the driving unit 14 (X′ axis), as shown in FIG. 6. Accordingly, when the rotating shaft 140 of the driving unit 14 rotates, the rotating shaft 140 can drive the reflecting member 16 to move between the first position shown in FIG. 4 and the second position shown in FIG. 5 along a direction perpendicular to the paper surface (Y′ Z′ plane). It should be noted that the same elements in FIGS. 4-6 and FIGS. 1-3 are represented by the same numerals, so the repeated explanation will not be depicted herein again.

As mentioned in the above, the invention disposes two light sources in the projection device and utilizes the driving unit to drive the reflecting member to move between two positions, so as to allow the light emitted by one of the two light sources to pass through the light integrator. Accordingly, when the projection device of the invention is operating, the two light sources can emit light by turns to extend the lifetime of the light source. Furthermore, by means of the configuration between the driving unit, the fan and the light source, the invention can enhance heat dissipation for the fan effectively.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A projection device comprising:
a first light source having a first light axis;
a second light source having a second light axis;
a driving unit, the driving unit and the first light source being located at opposite sides of the second light axis, the driving unit and the second light source being located at opposite sides of the first light axis;
a reflecting member connected to the driving unit, the driving unit driving the reflecting member to move between a first position and a second position; and
a light integrator located on the first light axis;
wherein when the reflecting member is located at the first position, the reflecting member is separated from the first light axis and the first light source emits a first light along the first light axis, such that the first light passes through the light integrator; when the reflecting member is located at the second position, the reflecting member intersects the second light axis, the second light source emits a second light along the second light axis, and the reflecting member reflects the second light to the light integrator, such that the second light passes through the light integrator.

2. The projection device of claim 1, wherein the driving unit has a rotating shaft, the reflecting member is connected to the rotating shaft, and a reflecting surface of the reflecting member is parallel to the rotating shaft.

3. The projection device of claim 1, wherein the driving unit has a rotating shaft, the reflecting member is connected to the rotating shaft, and a reflecting surface of the reflecting member is perpendicular to the rotating shaft.

4. The projection device of claim 1, further comprising:
a first fan disposed around the first light source, the first fan and the driving unit being located at an identical side of the first light axis; and
a second fan disposed around the second light source, the second fan and the driving unit being located at an identical side of the second light axis.

5. The projection device of claim 1, further comprising a third fan disposed at a side of the first light source and the second light source, the first light source has a first reflecting cover, the second light source has a second reflecting cover, and an axial center of the third fan is located between a focus point of the first reflecting cover and a focus point of the second reflecting cover.
